(19) United States
(12) Patent Application Publication
(10) Pub. No.: US 2023/0162027 A1
(43) Pub. Date: May 25, 2023

(54) COMPUTER-READABLE RECORDING MEDIUM STORING DISTRIBUTED LEARNING PROGRAM, INFORMATION PROCESSING DEVICE, AND DISTRIBUTED LEARNING METHOD

(71) Applicant: FUJITSU LIMITED, Kawasaki-shi (JP)

(72) Inventor: Yoshiharu Tajima, Yokohama (JP)

(73) Assignee: FUJITSU LIMITED, Kawasaki-shi (JP)

(21) Appl. No.: 17/885,591

(22) Filed: Aug. 11, 2022

(30) Foreign Application Priority Data
Nov. 24, 2021 (JP) 2021-189987

(51) Int. Cl. G06N 3/08; G06F 9/54

(52) U.S. Cl. CPC G06N 3/08; G06F 9/54

(57) ABSTRACT

A recording medium stores a program for causing a processor to execute processing including: in distributed learning where workers performs machine learning by using divided data, measuring each of unit training times of the workers; when performance of first workers deteriorates, calculating each of a first training time when causing each of second workers to perform machine learning in a first mode of distributing the divided data to the second workers and causing the second workers to process the divided data, and a second training time when performing machine learning in a second mode of causing each of the workers to perform the machine learning; executing the distributed learning in the first mode when the first training time is equal to or less than the second training time; and executing the distributed learning in the second mode when the first training time is longer than the second training time.

### CROSS-REFERENCE TO RELATED APPLICATION

This application is based upon and claims the benefit of priority of the prior Japanese Patent Application No. 2021-189987, filed on Nov. 24, 2021, the entire contents of which are incorporated herein by reference.

### FIELD

The embodiment discussed herein is related to a distributed learning program, an information processing device, and a distributed learning method.

### BACKGROUND

As a machine learning method in deep learning, distributed learning by data parallelism is known. In the distributed learning, a plurality of processes (workers) having the same neural network (model) is provided, different training data portions are input to the plurality of processes, and machine learning is performed. Hereinafter, the machine learning is sometimes referred to as training or simply referred to as learning.

Japanese Laid-open Patent Publication No. 2013-105377, Japanese Laid-open Patent Publication No. 2020-57161, and U.S. Pat. Application Publication No. 2016/0092765 are disclosed as related art.

### SUMMARY

According to an aspect of the embodiments, a non-transitory computer-readable recording medium stores a distributed learning program for causing a processor to execute processing including: in distributed learning where a plurality of workers performs machine learning in data parallel by using a plurality of divided data obtained by dividing training data, measuring each of unit training times of the plurality of workers; in a case where performance of one or more of first workers among the plurality of workers deteriorates, calculating each of a first training time required in a case of causing each of two or more second workers to perform machine learning in a first mode of distributing the divided data scheduled to be processed in the first worker to the second workers other than the first worker among the plurality of workers and causing the second workers to process the divided data, and a second training time required in a case of performing machine learning in a second mode of causing each of the plurality of workers which include the first worker to perform the machine learning; executing the distributed learning in the first mode in a case where the first training time required is equal to or less than the second training time required; and executing the distributed learning in the second mode in a case where the first training time required is longer than the second training time required.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a configuration of a computer system as an example of an embodiment;

FIG. 2 is a diagram illustrating a hardware configuration of a calculation node in the computer system as an example of the embodiment;

FIG. 3 is a diagram illustrating a functional configuration of a master calculation node in the computer system as an example of the embodiment;

FIG. 4 is a diagram for describing processing by a processing time calculation unit in the computer system of the embodiment;

FIG. 5 is a flowchart for describing processing in the computer system as an example of the embodiment;

FIG. 6 is a diagram for describing distributed learning by data parallelism; and

FIG. 7 is a diagram for comparing a processing time of a case where a delay has occurred in one process and a processing time at the time of degeneracy execution in distributed learning by data parallelism.

### DESCRIPTION OF EMBODIMENTS

Here, in one process of the machine learning, each processing of forward propagation (Fwd), backward propagation (Bwd), and update (Up.) is repeatedly performed. In the distributed learning using the plurality of processes, results of the backward propagation in all the processes are aggregated before update processing and an average is acquired, and the update processing is performed in each process using an average value.

In the backward propagation, weight gradient information can be obtained, which indicates how much weight of a neural network is to be changed next to update the weight so that an error (Loss) becomes small. Furthermore, in the update processing, values of various parameters are updated on the basis of an average of weight gradients obtained in the respective processes.

Aggregation of the training results (weight gradient information) among the plurality of processes is performed through communication between the processes, and for example, is implemented by Allreduce communication.

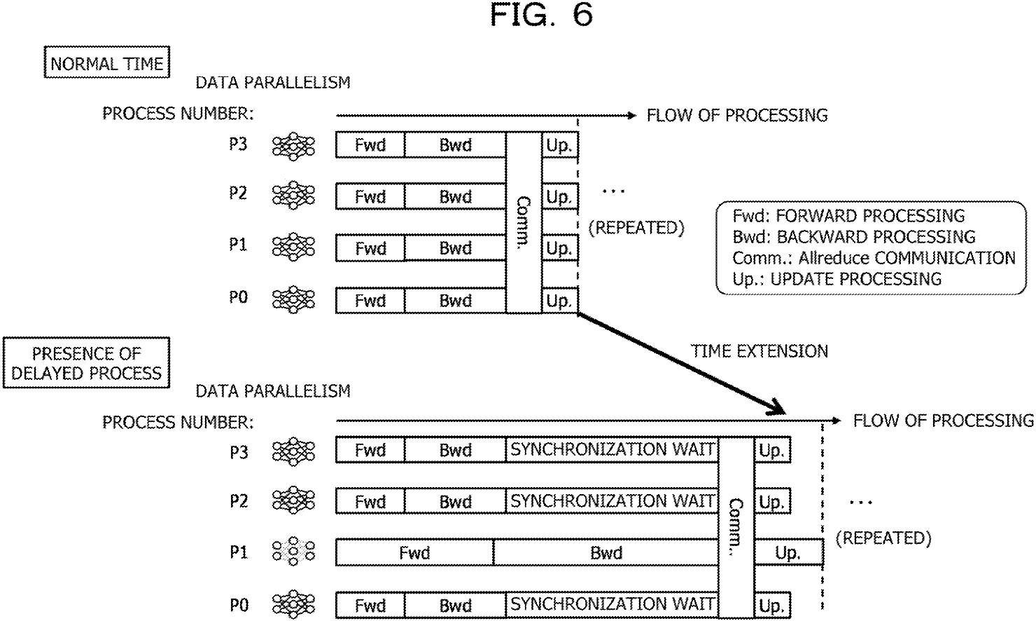

FIG. 6 is a diagram for describing distributed learning by data parallelism.

In FIG. 6, a processing time of each process at a normal time and a processing time of each process in a state with a delayed process (presence of a delayed process) are compared and illustrated. In FIG. 6, data parallel processing is performed by four processes P0 to P3, and in the state with a delayed process, forward propagation and backward propagation are delayed in the process P1.

In the distributed learning by data parallelism, communication is performed between the processes when training results of the respective processes are aggregated. However, if even one process is delayed, the entire processing time is extended for synchronization wait by other processes. In FIG. 6, synchronization wait occurs in which the processes P0, P2, and P3 wait for completion of the backward propagation by the process P1.

Therefore, methods have been known for preventing rate-limiting of entire performance due to such a delayed process. As one of the methods, a synchronous relaxation method is known for removing a process in which a delay has occurred (the process P1 in FIG. 6) from the training results to be aggregated and continuing training using learning results of only the remaining processes (the processes P0, P2, and P3 in FIG. 6) so as to prevent speed reduction. This method is called separation.

However, in the separation, machine learning becomes insufficient and learning accuracy is deteriorated due to exclusion of the process in which a delay has occurred from the training results to be aggregated.

Therefore, a synchronous relaxation method called degeneracy of distributing training data scheduled to be processed in the process in which a delay has occurs to other processes in which the delay has not occurred and causing the other processes to execute the training data is known. In the degeneracy, it is possible to prevent deterioration of the learning accuracy by additionally allocating training that is lacking due to exclusion of the process in which the delay has occurred to the remaining processes.

However, even if the above-described degeneracy is performed, the machine learning processing is not the shortest. Rather, by executing the degeneracy, the processing time is sometimes longer than a case of performing machine learning using the process in which a delay has occurred.

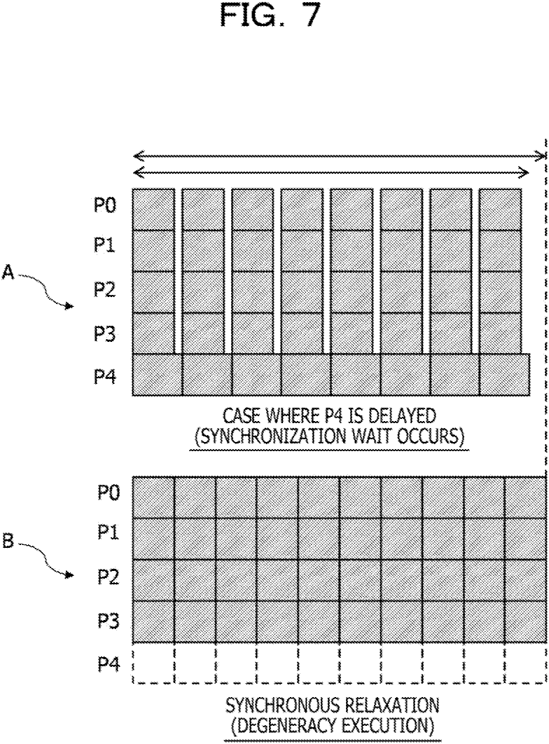

FIG. 7 is a diagram for comparing a processing time of a case where a delay has occurred in one process and a processing time at the time of degeneracy execution in distributed learning by data parallelism.

In FIG. 7, reference sign A indicates the processing time required for machine learning in the case where a delay has occurred in a process P4, which is one of a plurality of processes P0 to P4. In the example illustrated with reference sign A, each of the processes P0 to P4 learns eight iterations.

Meanwhile, in FIG. 7, reference sign B indicates the processing time required for machine learning in a case of stopping the process P4 by degeneracy and allocating the processing of the process P4 to the other processes P0 to P3. In the example illustrated with reference sign B, each of the processes P0 to P3 learns ten iterations.

In the example illustrated with reference sign B, the number of iterations processed by each process increases due to execution of the degeneracy, and the processing time required for machine learning is longer than that of the case (see reference sign A) of not performing degeneracy.

In one aspect, the embodiment aims to reduce the time required to complete machine learning in distributed learning in which machine learning is performed in data parallel.

Hereinafter, an embodiment of the present distributed learning program, information processing device, and distributed learning method will be described with reference to the drawings. Note that the embodiment to be described below is merely examples, and there is no intention to exclude application of various modifications and techniques not explicitly described in the embodiment. For example, the present embodiment may be variously modified and carried out without departing from the gist thereof. Furthermore, each drawing is not intended to include only components illustrated in the drawing, and may include another function and the like.

### (A) Configuration

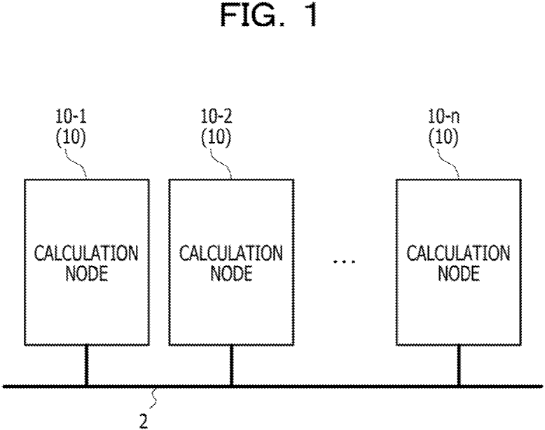

FIG. 1 is a diagram schematically illustrating a configuration of a computer system 1 as an example of an embodiment. As illustrated in FIG. 1, the computer system 1 as an example of the embodiment includes a plurality of (n in the example illustrated in FIG. 1) calculation nodes 10-1 to 10-n.

These calculation nodes 10-1 to 10-n are connected to be communicable with each other via a network 2. The calculation nodes 10-1 to 10-n have configurations similar to each other. Hereinafter, in a case where the calculation nodes 10-1 to 10-n are not particularly distinguished, the calculation nodes 10-1 to 10-n are referred to as calculation node(s) 10.

The present computer system 1 performs machine learning in deep learning, and implements distributed learning by data parallelism using the plurality of calculation nodes 10. One or more processes (workers) having the same neural network (model) are provided in each calculation node 10 and these processes respectively execute processes of the machine learning in parallel. The present computer system 1 performs the distributed learning (training) by inputting different training data portions (divided data) to the plurality of processes and causing the processes to process the training data in parallel. The distributed learning may be called distributed machine learning.

In the present embodiment, an example in which one process (worker) is provided in each calculation node 10 is given.

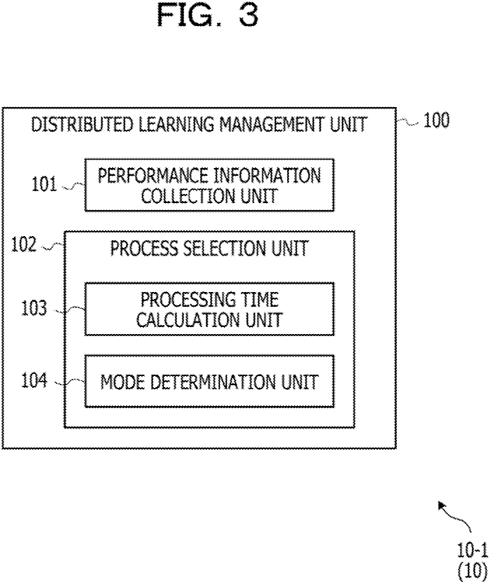

Furthermore, in the present computer system 1, the calculation node 10-1 of the plurality of calculation nodes 10 functions as a master (primary) and implements a function as a distributed learning management unit 100 to be described below with reference to FIG. 3. Furthermore, at the time of a failure of this master calculation node 10-1, any one calculation node 10 of the calculation nodes 10-2 to 10-n (for example, the calculation node 10-2) takes over an operation of the calculation node 10-1 as a master.

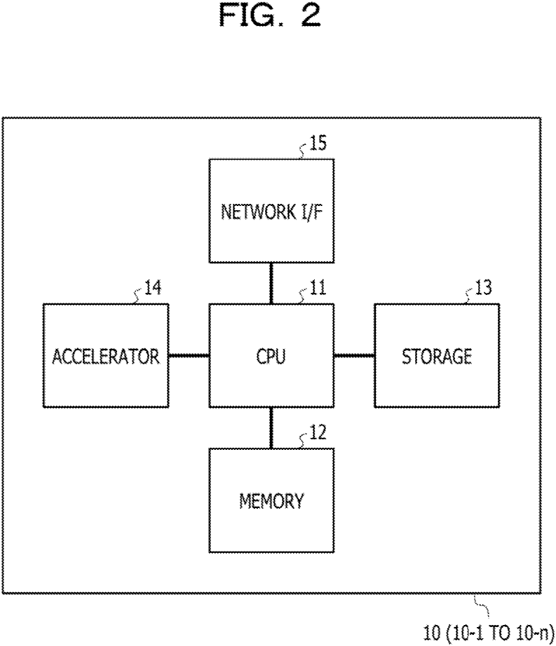

FIG. 2 is a diagram illustrating a hardware configuration of the calculation node 10 in the computer system 1 as an example of the embodiment.

As illustrated in FIG. 2, the calculation node 10 includes a central processing unit (CPU) 11, a memory 12, a storage 13, an accelerator 14, and a network interface (I/F) 15.

The memory 12 is used as a main storage device of the calculation node 10. The memory 12 temporarily stores at least a part of an operating system (OS) program or an application program to be executed by the CPU 11. Furthermore, the memory 12 stores various types of data needed for processing by the CPU 11. The application program may include a distributed learning program (not illustrated) executed by the CPU 11 so as to implement the function as the distributed learning management unit 100 according to the present embodiment by the calculation node 10.

The storage 13 is a storage device such as a hard disk drive (HDD), a solid state drive (SSD), or a storage class memory (SCM) and is configured to store various kinds of data. The storage 13 is used as an auxiliary storage device of the calculation node 10. The storage stores the OS program, the application program, and various types of data.

The accelerator 14 is a processing device that performs specific arithmetic processing and is, for example, a graphics processing unit (GPU). In the present embodiment, an example in which the CPU (control unit) 11 executes the above-described application program (distributed learning program) so as to implement the function as the distributed learning management unit 100 is given. However, the present embodiment is not limited to this. For example, the accelerator 14 may implement the function as the distributed learning management unit 100 by executing the machine learning program.

The network interface 15 is connected to the network 2. The network interface 15 transmits and receives data to and from another calculation node 10 or another communication device (not illustrated) via the network 2.

With the calculation node 10 having the hardware configuration as described above, the function (distributed learning function) as the distributed learning management unit 100 according to the present embodiment to be described below can be implemented.

The calculation node 10 that functions as a master (for example, the calculation node 10-1) implements a distributed learning management function of the present embodiment by executing a program (machine learning program or the like) recorded in, for example, a computer-readable non-transitory recording medium. The program in which processing content to be executed by the calculation node 10 is described may be recorded in various recording media. For example, the program to be executed by the calculation node 10 may be stored in the storage 13. The CPU 11 loads at least a part of the program in the storage 13 to the memory 12 and executes the loaded program.

Furthermore, the program to be executed by the calculation node 10 (CPU 11) can be recorded in a non-transitory portable recording medium such as an optical disk, a memory device, or a memory card. The program stored in the portable recording medium becomes able to be executed after being installed to the storage 13, for example, under control by the CPU 11. Furthermore, the CPU 11 may directly read and execute the program from the portable recording medium.

The CPU (processing unit) 11 is a control unit that controls the entire calculation node 10. The CPU 11 may be a multiprocessor. Instead of the CPU 11, any one of a micro processing unit (MPU), a digital signal processor (DSP), an application specific integrated circuit (ASIC), a programmable logic device (PLD), or a field programmable gate array (FPGA) may be used. Furthermore, instead of the CPU 11, a combination of two or more types of elements of the CPU, MPU, DSP, ASIC, PLD, and FPGA may be used.

FIG. 3 is a diagram illustrating a functional configuration of the master calculation node 10-1 in the computer system 1 as an example of the embodiment.

As illustrated in FIG. 3, the CPU 11 of the master calculation node 10-1 implements the function as the distributed learning management unit 100 by executing the distributed learning program.

The distributed learning management unit 100 has functions as a performance information collection unit 101 and a process selection unit 102.

The performance information collection unit 101 collects performance information of each calculation node 10 (CPU 11). The performance information collection unit 101 measures a processing time required for processing one iteration for each process.

The processing time required for processing one iteration by a process corresponds to a unit training time of the process. The unit training time changes according to a processing load or the like of the calculation node 10 that executes the process.

Note that the time required for processing the iteration by the process can be obtained using a known method, and description thereof will be omitted.

The distributed learning management unit 100 may detect a processing delay in the process by comparing the processing time required for processing one iteration of each process collected by the performance information collection unit 101 with a predetermined threshold value.

The process selection unit 102 selects a process to be used for distributed learning by data parallelism.

As illustrated in FIG. 3, the process selection unit 102 has functions as a processing time calculation unit 103 and a mode determination unit 104.

The processing time calculation unit 103 calculates a time required for training a machine learning model using training data.

As described above, the present computer system 1 performs data parallel distributed learning by causing the plurality of processes to have the same machine learning model and inputting different training data portions (divided data of the training data) to the plurality of processes.

Then, the present computer system 1 is provided with degeneracy as an optimization method of machine learning in a case where a delay has occurred in at least one process. The degeneracy is a countermeasure (performance stabilization method) for stabilizing a calculation speed of the computer system 1 in a case where processing performance varies among the plurality of processes (calculation nodes 10).

Hereinafter, the process with a delay in the processing may be referred to as a delayed process. Furthermore, the calculation node 10 that implements the delayed process may be referred to as a delayed calculation node 10.

In the degeneracy, the delayed process is excluded from training, and the machine learning is performed in other processes than the delayed process.

Hereinafter, the process excluded from training by degeneracy may be referred to as an exclusion process. Furthermore, the processes other than the exclusion process among the plurality of processes may be referred to as inclusion processes. In the present embodiment, a case where the number of exclusion processes is one will be described.

The distributed learning management unit 100 performs control to exclude the exclusion process from training (communication group) by excluding, for example, the exclusion process from a participating group of Allreduce communication. Excluding the exclusion process from the participating group of the Allreduce communication may be said to separate the exclusion process.

Then, the distributed learning management unit 100 distributes the training data scheduled to be processed in the exclusion process to processes (calculation nodes 10) other than the exclusion process among the plurality of processes and causes the processes to execute the training data.

In the degeneracy, the divided data scheduled to be processed in the exclusion process (first worker) is distributed to and processed by two or more inclusion processes (second workers) other than the exclusion process among the plurality of processes. The degeneracy corresponds to a first mode.

Meanwhile, the distributed learning for causing each of all the processes including the delayed process to perform the machine learning in a state where synchronous relaxation processing is not executed without applying a synchronous relaxation method such as the degeneracy may be referred to as a second mode. No degeneracy is performed in the second mode. Therefore, the second mode may be referred to as a non-degeneracy mode.

The processing time calculation unit 103 calculates (estimates) each time (time required) required for training using the training data, for each case of when the synchronous relaxation processing is not executed and when the degeneracy is executed, using the processing time of each process collected by the performance information collection unit 101.

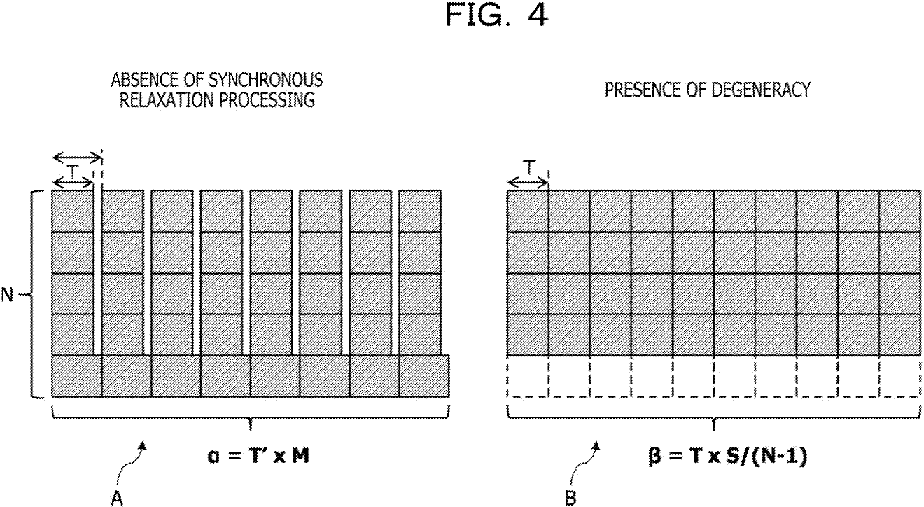

FIG. 4 is a diagram for describing processing by the processing time calculation unit 103 in the computer system 1 of the embodiment.

In FIG. 4, reference sign A indicates a training time when the synchronous relaxation processing is not executed (without the synchronous relaxation processing) at the time of occurrence of the delayed process and reference sign B indicates a training time when the degeneracy is executed (with the degeneracy).

The processing time calculation unit 103 calculates a time (total training time) α required for training one epoch when the synchronous relaxation processing is not executed at the time of occurrence of the delayed process, using the following equation (1) (see reference sign A in FIG. 4).

The total training time when the synchronous relaxation processing is not executed α = T′ × M ^{...} (1)

Here, T′ is the processing time per iteration of the delayed process. M is the number of iterations required for learning one epoch, and is the number of iterations when the synchronous relaxation processing is not executed. In the example illustrated in FIG. 4, M = 8.

The total training time α corresponds to a second training time required (α = T’M) in the case of performing the machine learning in the second mode (non-degeneracy mode) of causing each of the plurality of processes including the delayed process to perform the machine learning.

The processing time calculation unit 103 calculates the total training time α by multiplying the number of iterations (M) required for learning one epoch by the unit training time (T′) of the delayed process.

Furthermore, the processing time calculation unit 103 calculates a time (total training time) β required for training one epoch when the degeneracy is executed at the time of occurrence of the delayed process, using the following equation (2) (see reference sign B in FIG. 4).

The total training time when the degeneracy is executed β = T × S/(N - 1) ^{...} (2)

Here, T is the processing time per iteration of the process without a delay (normal process). S is a processed data amount (total training amount) in training, and is calculated by S = N × M. N is the total number of processes.

In the above equation (2), S/(N - 1) represents the number of iterations M′ when the degeneracy is executed. In the example illustrated in FIG. 4, M′ = 10. The above equation (2) may be expressed by the following equation (3).

The total training time when the degeneracy is executed β = T × M′ ^{...} (3)

The total training time β corresponds to a first training time required in a case of causing each of the inclusion processes (second workers) to perform the machine learning.

The processing time calculation unit 103 calculates the total training time β by multiplying a value (S/(N - 1)) by the unit training time of the inclusion process, the value being obtained by dividing the processed data amount (S) of the training data by the number of inclusion processes (N - 1).

The total training times α and β calculated by the processing time calculation unit 103 are stored in a predetermined storage area of the memory 12 or the storage 13.

The mode determination unit 104 determines whether to perform the degeneracy (degeneracy mode) or the distributed learning without executing the degeneracy (non-degeneracy mode) on the basis of the total training time α when the synchronous relaxation processing is not executed and the total training time β when the degeneracy is executed, which have been calculated by the processing time calculation unit 103.

For example, the mode determination unit 104 compares the total training time α when the synchronous relaxation processing is not executed with the total training time β when the degeneracy is executed.

Then, the mode determination unit 104 determines to execute the degeneracy (selects the degeneracy mode) in a case where the total training time β (= TM′) when the degeneracy is executed is equal to or smaller than the total training time α (= T’M) when the synchronous relaxation processing is not executed. On the other hand, the mode determination unit 104 determines not to execute the degeneracy (selects the non-degeneracy mode) in a case where the total training time β (= TM′) when the degeneracy is executed is longer than the total training time α (= T′M) when the synchronous relaxation processing is not executed.

The mode determination unit 104 may store information indicating a determination result (degeneracy mode/non-degeneracy mode) in a predetermined storage area of the memory 12 or the storage 13.

The distributed learning management unit 100 implements the distributed learning according to the determination result of the mode determination unit 104.

In the case where the mode determination unit 104 determines the degeneracy mode, the distributed learning management unit 100 performs control to exclude the exclusion process from the training (communication group) by excluding the exclusion process from the participating group of the Allreduce communication. Furthermore, the distributed learning management unit 100 distributes the training data scheduled to be processed in the exclusion process to the processes (calculation nodes 10) other than the exclusion process among the plurality of processes and causes the processes to execute the training data.

Meanwhile, in the case where the mode determination unit 104 determines the non-degeneracy mode, the distributed learning management unit 100 continuously performs the distributed learning by the plurality of processes including the delayed process.

### (B) Operation

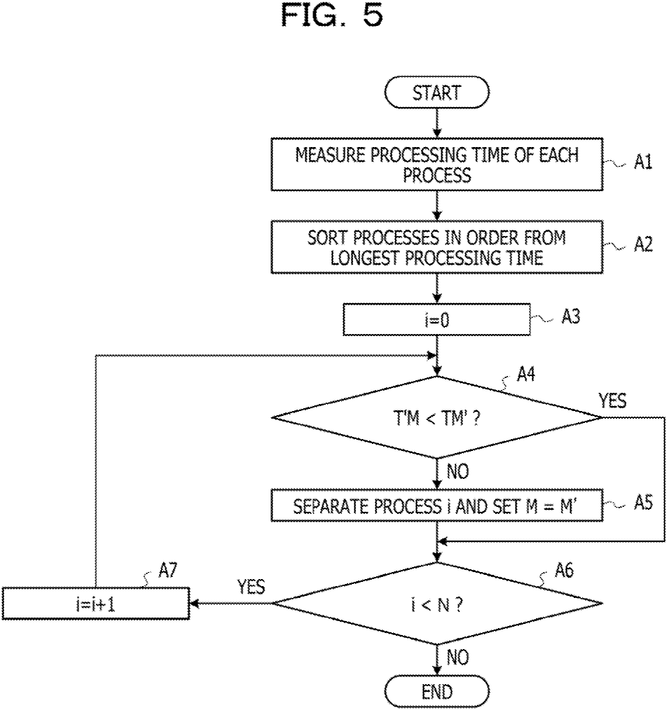

The processing in the computer system 1 as an example of the embodiment configured as described above will be described with reference to a flowchart (steps A1 to A7) illustrated in FIG. 5.

It is desirable that the processing illustrated in FIG. 5 is periodically and repeatedly performed at, for example, the master calculation node 10-1 after the start of distributed learning.

In step A1, the performance information collection unit 101 measures each processing time required for processing one iteration for all the processes in the present computer system 1.

In step A2, the processing time calculation unit 103 sorts the plurality of processes in order from the longest processing time on the basis of the processing time per iteration of each process collected by the performance information collection unit 101.

In step A3, the mode determination unit 104 initializes a variable i (i = 0). The variable i represents any process among the plurality of sorted processes in step A2, and i = 0 represents the first process among the plurality of sorted processes. The process selection unit 102 determines whether or not to perform the degeneracy of the process specified by the variable i. The process specified by the variable i may be referred to as a process to be determined.

The processing time calculation unit 103 calculates the total training time α (= T′M) when the synchronous relaxation processing is not executed and the total training time β (= TM′) when the degeneracy is executed.

In step A4, the mode determination unit 104 compares the total training time α (= T′M) when the synchronous relaxation processing is not executed with the total training time β (= TM′) when the degeneracy is executed for the process to be determined i. The mode determination unit 104 confirms whether the total training time β (= TM′) when the degeneracy is executed is larger than the total training time α (= T′M) when the synchronous relaxation processing is not executed (T′M < TM′).

As a result of the confirmation, in a case where the total training time β (= TM′) when the degeneracy is executed is equal to or smaller than the total training time α (= T′M) when the synchronous relaxation processing is not executed (T′M ≥ TM′) (see the NO route in step A4), the mode determination unit 104 selects the degeneracy mode, and the processing proceeds to step A5. In the degeneracy mode, the process to be determined is treated as the exclusion process.

In step A5, the distributed learning management unit 100 executes the degeneracy. In this degeneracy, the distributed learning management unit 100 separates the process to be determined. For example, the distributed learning management unit 100 performs control to exclude the exclusion process (process to be determined) from the training (communication group) by excluding the exclusion process (process to be determined) from the participating group of the Allreduce communication. Furthermore, the distributed learning management unit 100 distributes the training data scheduled to be processed in the exclusion process to the processes (calculation nodes 10) other than the exclusion process among the plurality of processes and causes the processes to execute the training data. Furthermore, the processing time calculation unit 103 updates the number of iterations M, using the number of iterations M′ when the degeneracy is executed.

In step A6, the mode determination unit 104 confirms whether i is less than the total number of processes N (i < N). As a result of the confirmation, in a case where i is less than the total number of processes N (see the YES route in step A6), the processing proceeds to step A7.

In step A7, the mode determination unit 104 increments i (i = i + 1), and then the processing time calculation unit 103 returns to step A4.

Furthermore, as a result of the confirmation in step A4, in a case where the total training time α (= T′M) when the synchronous relaxation processing is not executed is less than the total training time β (= TM′) when the degeneracy is executed (T′M < TM) (see the YES route in step A4), the mode determination unit 104 selects the non-degeneracy mode, and the distributed learning management unit 100 causes the plurality of processes including the delayed process to continuously perform the distributed learning. The processing proceeds to step A6.

As a result of the confirmation in step A6, in a case where i is equal to or larger than the total number of processes N (i ≥ N) (see the NO route in step A6), the processing is terminated.

### (C) Effects

As described above, according to the computer system 1 as an example of the embodiment, in the data parallel distributed learning, the processing time calculation unit 103 calculates the total training time β (= TM′) when the degeneracy is executed and the total training time α (= T’M) when the synchronous relaxation processing is not executed.

Then, the mode determination unit 104 determines to execute the degeneracy (selects the degeneracy mode) in the case where the total training time β (= TM′) when the degeneracy is executed is equal to or smaller than the total training time α (= T′M) when the degeneracy is not executed. In response to the determination by the mode determination unit 104, the distributed learning management unit 100 executes the degeneracy.

Thereby, by executing the degeneracy, the total training time can be certainly shortened as compared with the case where the synchronous relaxation processing is not executed. Furthermore, in the degeneracy, the learning accuracy is not deteriorated by causing the plurality of inclusion processes to process the training data allocated to the exclusion process in a distributed manner.

Furthermore, the mode determination unit 104 determines not to execute the degeneracy (selects the non-degeneracy mode) in the case where the total training time β (= TM′) when the degeneracy is executed is longer than the total training time α (= T′M) when the synchronous relaxation processing is not executed.

Thereby, the total training time can be certainly shortened in the case where the synchronous relaxation processing is not executed as compared with the case where the degeneracy is executed. Since the delayed process processes the training data allocated to the delayed process, the learning accuracy is not deteriorated.

Therefore, it is possible to shorten (minimize) the time until the training is completed while maintaining the training accuracy of the distributed learning in deep learning.

### (D) Others

Each configuration and each processing of the present embodiment may be selected or omitted as needed or may be appropriately combined.

Then, the disclosed technique is not limited to the embodiment described above, and various modifications may be made and carried out without departing from the gist of the present embodiment.

For example, in the embodiment described above, an example is indicated in which the calculation node 10-1 of the plurality of calculation nodes 10 included in the computer system 1 functions as a master (primary) and implements the function as the distributed learning management unit 100. However, the embodiment is not limited to this. A management device different from the calculation node 10 may be provided in the computer system 1, and the management device may implement the function as the distributed learning management unit 100.

Furthermore, in the embodiment described above, an example is indicated in which one of the separation and the degeneracy is selected as the performance stabilization method in a case where the processing performances of the plurality of calculation nodes 10 vary. However, the embodiment is not limited to this. A method other than the separation and the degeneracy may be used as the stabilization method.

Furthermore, the present embodiment may be carried out and manufactured by those skilled in the art according to the disclosure described above.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a distributed learning program for causing a processor to execute processing comprising:
in distributed learning where a plurality of workers performs machine learning in data parallel by using a plurality of divided data obtained by dividing training data, measuring each of unit training times of the plurality of workers;
in a case where performance of one or more of first workers among the plurality of workers deteriorates, calculating each of a first training time required in a case of causing each of two or more second workers to perform machine learning in a first mode of distributing the divided data scheduled to be processed in the first worker to the second workers other than the first worker among the plurality of workers and causing the second workers to process the divided data, and a second training time required in a case of performing machine learning in a second mode of causing each of the plurality of workers which include the first worker to perform the machine learning;
executing the distributed learning in the first mode in a case where the first training time required is equal to or less than the second training time required; and
executing the distributed learning in the second mode in a case where the first training time required is longer than the second training time required.

2. The non-transitory computer-readable recording medium according to claim 1, wherein the processing of calculating the first training time required includes processing of multiplying a value obtained by dividing a processed data amount of the training data by the number of the second workers, by the unit training time of the second worker.

3. The non-transitory computer-readable recording medium according to claim 1, wherein the processing of calculating the second training time required includes processing of multiplying the number of iterations required for learning one epoch by the unit training time of the first worker.

4. An information processing device comprising:
a memory; and
a processor coupled to the memory and configured to:
in distributed learning where a plurality of workers performs machine learning in data parallel by using a plurality of divided data obtained by dividing training data, measure each of unit training times of the plurality of workers;
in a case where performance of one or more of first workers among the plurality of workers deteriorates, calculate each of a first training time required in a case of causing each of two or more second workers to perform machine learning in a first mode of distributing the divided data scheduled to be processed in the first worker to the second workers other than the first worker among the plurality of workers and causing the second workers to process the divided data, and a second training time required in a case of performing machine learning in a second mode of causing each of the plurality of workers which include the first worker to perform the machine learning;
execute the distributed learning in the first mode in a case where the first training time required is equal to or less than the second training time required; and
execute the distributed learning in the second mode in a case where the first training time required is longer than the second training time required.

5. The information processing device according to claim 4, wherein the processing of calculating the first training time required includes processing of multiplying a value obtained by dividing a processed data amount of the training data by the number of the second workers, by the unit training time of the second worker.

6. The information processing device according to claim 4, wherein the processing of calculating the second training time required includes processing of multiplying the number of iterations required for learning one epoch by the unit training time of the first worker.

7. A distributed learning method comprising:
in distributed learning where a plurality of workers performs machine learning in data parallel by using a plurality of divided data obtained by dividing training data, measuring each of unit training times of the plurality of workers;
in a case where performance of one or more of first workers among the plurality of workers deteriorates, calculating each of a first training time required in a case of causing each of two or more second workers to perform machine learning in a first mode of distributing the divided data scheduled to be processed in the first worker to the second workers other than the first worker among the plurality of workers and causing the second workers to process the divided data, and a second training time required in a case of performing machine learning in a second mode of causing each of the plurality of workers which include the first worker to perform the machine learning;
executing the distributed learning in the first mode in a case where the first training time required is equal to or less than the second training time required; and
executing the distributed learning in the second mode in a case where the first training time required is longer than the second training time required.

8. The distributed learning method according to claim 7, wherein the processing of calculating the first training time required includes processing of multiplying a value obtained by dividing a processed data amount of the training data by the number of the second workers, by the unit training time of the second worker.

9. The distributed learning method according to claim 7, wherein the processing of calculating the second training time required includes processing of multiplying the number of iterations required for learning one epoch by the unit training time of the first worker.
